(19) United States
(12) Patent Application Publication
(10) Pub. No.: US 2005/0139234 A1
(43) Pub. Date: Jun. 30, 2005

(54) Method of cleaning substrate processing apparatus and computer-readable recording medium

(75) Inventors: Kazuya Dobashi, Nirasaki-shi (JP); Yasuhiro Oshima, Nirasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/028,585

(22) Filed: Jan. 5, 2005

Related U.S. Application Data
(63) Continuation-in-part of application No. PCT/JP03/08318, filed on Jul. 1, 2003.

(30) Foreign Application Priority Data
Jul. 5, 2002 (JP) P2002-197364

(51) Int. Cl. B08B 7/00

(52) U.S. Cl. 134/19; 134/22.1

(57) ABSTRACT

A process chamber having an insulative substance adhering thereto is heated to not lower than 300° C. nor higher than 450° C. and a cleaning gas containing β diketone and one of water and alcohol is supplied into the process chamber. When the cleaning gas supplied into the process chamber adheres to an inner wall of the process chamber and a susceptor to be in contact with the insulative substance, a complex of a substance composing the insulative substance is formed. The complex easily vaporizes owing to a high vapor pressure, to be discharged out of the process chamber by the exhaust of the inside of the process chamber.

### CROSS REFERENCE TO RELATED APPLICATION

This is a Continuation-in-part Application of PCT Application No. PCT/JP03/08318, filed on Jul. 1, 2003, which was not published under PCT Article 21(2) in English. This application is based upon and claims the benefit of priority from the prior Japanese Patent Application No. 2002-197364, filed Jul. 5, 2002, the entire contents of which are incorporated herein by reference.

### BACKGROUND OF THE INVENTION

1. Field of the Invention

The present invention relates to a method of cleaning a substrate processing apparatus that processes a substrate and to a computer-readable recording medium.

2. Description of the Related Art

As a film deposition apparatus for forming a thin film made of a high-dielectric substance such as HfO₂ on a semiconductor wafer (hereinafter, simply referred to as a “wafer”), a film deposition apparatus that chemically forms a thin film has been conventionally known. In such a film deposition apparatus, a wafer is heated and a process gas is used to form a thin film on the wafer.

The high-dielectric substance adheres to an inner wall of a process chamber, a susceptor disposed in the process chamber, and so on after the thin film is formed on the wafer. If the thin film of the high-dielectric substance is formed on the wafer while the inner wall of the process chamber and so on have the high-dielectric substance adhering thereto, the high-dielectric substance adhering to the inner wall of the process chamber and so on sometimes peels off the inner wall of the process chamber and so on to contaminate the wafer. In order to prevent this, the inside of the process chamber is regularly cleaned to remove the high-dielectric substance adhering to the inner wall of the process chamber and so on.

Various methods are currently used for cleaning the inside of the process chamber. For example, Japanese Patent Laid-open Application No. 2000-96241 describes a cleaning method of the inside of a process chamber by using hexafluoroacetylacetone (Hhfac) or the like. Here, this patent document describes that the cleaning condition are such that the temperature of the inside of the process chamber is 200° C. to 300° C. and the pressure in the process chamber is lower than 200 Pa. However, there is a problem that a sufficient cleaning effect cannot be obtained under this condition.

### BRIEF SUMMARY OF THE INVENTION

The present invention was made in order to solve the conventional problems stated above. Specifically, it is an object of the present invention to provide a method of cleaning a substrate processing apparatus capable of providing a sufficient cleaning effect and to provide a computer-readable recording medium.

A method of cleaning a substrate processing apparatus according to one of the aspects of the present invention includes: supplying a cleaning gas containing β-diketone and one of water and alcohol into a process chamber of the substrate processing apparatus, with an insulative substance adhering to an inner part thereof, while the process chamber is set under a temperature that has been raised to not lower than 300° C. nor higher than 450° C., to cause a reaction of the insulative substance and the β-diketone contained in the cleaning gas, thereby forming a complex of a substance composing the insulative substance; and discharging the complex out of the process chamber. The method of cleaning the substrate processing apparatus of this invention can provide a sufficient cleaning effect since it includes the forming of the complex using one of water and alcohol as a catalyst.

A method of cleaning a substrate processing apparatus according to another aspect of the present invention includes: supplying a cleaning gas containing hexafluoroacetylacetone into a process chamber of the substrate processing apparatus having an insulative substance adhering to an inner part thereof, while the process chamber is set under a temperature that has been raised to not lower than 300° C. nor higher than 450° C. and the inner part of the process chamber is kept at a pressure of not lower than 1.33×10³ Pa nor higher than 1.33×10⁴ Pa, to cause a reaction of the insulative substance and the hexafluoroacetylacetone contained in the cleaning gas, thereby forming a complex of a substance composing the insulative substance; and discharging the complex out of the process chamber. The method of cleaning the substrate processing apparatus of this invention can provide a sufficient cleaning effect since it includes the optimum forming of the complex.

A method of cleaning a substrate processing apparatus according to still another aspect of the present invention includes: supplying a cleaning gas containing β-diketone and oxygen into a process chamber of the substrate processing apparatus having an insulative substance adhering to an inner part thereof, to cause a reaction of the insulative substance and the β-diketone, thereby forming a complex of a substance composing the insulative substance; and discharging the complex out of the process chamber. The method of cleaning the substrate processing apparatus of this invention can provide a sufficient cleaning effect since it includes the forming of the complex.

Preferably, the forming of the complex and the discharge of the complex are alternately repeated. Such repetition of the forming of the complex and the discharge of the complex results in more reliable formation and discharge of the complex.

The insulative substance may be a high-dielectric substance containing at least one kind out of aluminum (Al), zirconium (Zr), hafnium (Hf), lanthanum (La), yttrium (Y), praseodymium (Pr), and cerium (Ce). Even when such a high-dielectric substance adheres to the inside of the process chamber, it is possible to surely remove the high-dielectric substance from the process chamber.

Preferably, a content ratio of one of the water and the alcohol in the cleaning gas is not lower than 50 ppm nor higher than 5000 ppm. The cleaning gas containing the water or alcohol at such a ratio can further improve cleaning efficiency.

Preferably, the cleaning gas contains an oxygen gas. When the oxygen is contained in the cleaning gas, a sufficient cleaning effect can be obtained.

Preferably, the β-diketone is a substance represented as R¹(CO)CH₂(CO)R², R¹ and R² independently are an alkyl and a haloalkyl. The use of such a substance as the β-diketone makes it possible to surely form the complex.

Preferably, the β-diketone is hexafluoroacetylacetone. The use of hexafluoroacetylacetone as the β-diketone facilitates forming the complex.

A recording medium according to yet another aspect of the present invention is a computer-readable recording medium in which a computer program controlling a substrate processing apparatus is recorded, wherein the computer program comprises: controlling the substrate processing apparatus to supply a cleaning gas containing β-diketone and one of water and alcohol into a process chamber of the substrate processing apparatus having an insulative substance adhering to an inner part thereof, while the process chamber is set under a temperature that has been raised to not lower than 300° C. nor higher than 450° C., to cause a reaction of the insulative substance and the β-diketone contained in the cleaning gas, thereby forming a complex of a substance composing the insulative substance; and controlling the substrate processing apparatus to discharge the complex out of the process chamber.

A recording medium according to yet another aspect of the present invention is a computer-readable recording medium in which a computer program controlling a substrate processing apparatus is recorded, wherein the computer program comprises: controlling the substrate processing apparatus to supply a cleaning gas containing hexafluoroacetylacetone into a process chamber of the substrate processing apparatus having an insulative substance adhering to an inner part thereof, while the process chamber is set under a temperature that has been raised to not lower than 300° C. nor higher than 450° C. and the inner part of the process chamber is kept at a pressure of not lower than 1.33×10³ Pa nor higher than 1.33×10⁴ Pa, to cause a reaction of the insulative substance and the hexafluoroacetylacetone contained in the cleaning gas, thereby forming a complex of a substance composing the insulative substance; and controlling the substrate processing apparatus to discharge the complex out of the process chamber.

According to yet another aspect of a recording medium of the present invention is a computer-readable recording medium in which a computer program controlling a substrate processing apparatus is recorded, wherein the computer program comprises: controlling the substrate processing apparatus to supply a cleaning gas containing β-diketone and oxygen into a process chamber of the substrate processing apparatus having an insulative substance adhering to an inner part thereof, to cause a reaction of the insulative substance and the β-diketone, thereby forming a complex of a substance composing the insulative substance; and controlling the substrate processing apparatus to discharge the complex out of the process chamber.

### BRIEF DESCRIPTION OF THE DRAWINGS

FIG. 1 is a vertical cross-sectional view schematically showing a CVD apparatus according to a first embodiment.

FIG. 2 is a view schematically showing a process gas supply system and a cleaning gas supply system of the CVD apparatus according to the first embodiment.

FIG. 3 is a flowchart showing the flow of film deposition performed in the CVD apparatus according to the first embodiment.

FIG. 4 is a flowchart showing the flow of cleaning of the CVD apparatus according to the first embodiment.

FIG. 5A and FIG. 5B are vertical cross-sectional views schematically showing a cleaning process of the CVD apparatus according to the first embodiment.

FIG. 6A and FIG. 6B are graphs showing the correlation between the temperature of a susceptor of the CVD apparatus and the etch rate of an insulative film formed on a wafer, according to an example 1.

FIG. 7A is a diagram schematically showing a chemical structure of Hhfac and FIG. 7B is a diagram schematically showing a chemical structure of a metal complex formed by Hhfac.

FIG. 8A and FIG. 8B are graphs showing the correlation between the temperature of the susceptor of the CVD apparatus and the etch rate of an insulative film formed on a wafer, according to a comparative example 1.

FIG. 9A and FIG. 9B are graphs showing the correlation between the temperature of the susceptor of the CVD apparatus and the etch rate of an insulative film formed on a wafer, according to a comparative example 2.

FIG. 10 is a graph showing the correlation between the flow rate of O₂ and the etch rate of a HfO₂ film, according to an example 2.

FIG. 11A to FIG. 11C are graphs showing the correlation of the etch rate of a HfO₂ film relative to the process pressure of a cleaning gas, the process temperature, and the flow rate of Hhfac, according to an example 3.

FIG. 12A is a graph showing the correlation between the concentration of water in a cleaning gas and the etch rate of a Hfo₂ film and FIG. 12B is a graph showing the correlation between the concentration of ethanol in a cleaning gas and the etch rate of a HfO₂ film.

FIG. 13 is a flow chart showing the flow of cleaning of the CVD apparatus, according to a second embodiment.

FIG. 14A and FIG. 14B are vertical cross-sectional views schematically showing a cleaning process of the CVD apparatus according to the second embodiment.

FIG. 15 is a flowchart showing the flow of cleaning of the CVD apparatus, according to a third embodiment.

### DESCRIPTION OF THE EMBODIMENTS

### First Embodiment

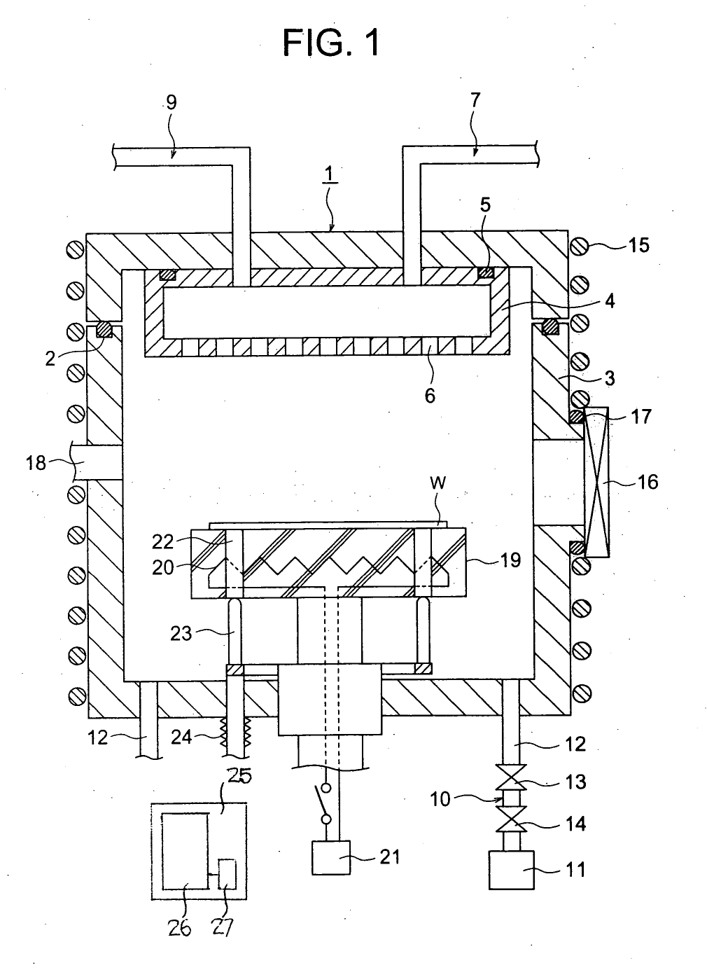

Hereinafter, a substrate processing apparatus according to a first embodiment of the present invention will be described. In the description of this embodiment, a CVD (Chemical Vapor Deposition) apparatus to chemically form a thin film on a film deposition surface of a wafer as a substrate will be used as the substrate processing apparatus. FIG. 1 is a vertical cross-sectional view schematically showing the CVD apparatus according to this embodiment.

As shown in FIG. 1, a CVD apparatus 1 is formed of, for example, aluminum or stainless steel and has a substantially cylindrical shape. The CVD apparatus 1 has a process chamber 3 having an O-ring 2 provided therein.

A showerhead 4 is disposed on a ceiling of the process chamber 3 via an O-ring 5 to face a later-described susceptor 19. The showerhead 4 supplies into the process chamber 3 a process gas for forming a thin film of an insulative substance on a film deposition surface of a wafer W and a cleaning gas for removing the insulative substance that adheres to the inside of the process chamber during film deposition.

The showerhead 4 has a hollow structure and a plurality of discharge ports 6 are bored in a bottom of the showerhead 4. The plural discharge ports 6 are bored, so that the process gas and the cleaning gas supplied into the showerhead 4 can be uniformly discharged.

A later-described process gas supply system 7 to supply the process gas and a later-described cleaning gas supply system 9 to supply the cleaning gas are attached to a top portion of the showerhead 4.

Vacuum exhaust systems 10 to vacuum-exhaust the inside of the process chamber 3 are connected to a bottom of the process chamber 3. Each of the vacuum exhaust systems 10 is mainly composed of a vacuum pump 11 such as a turbo-molecular pump or a dry pump, an exhaust pipe 12 connected to the vacuum pump 11 and the bottom of the process chamber 3, a shutoff valve 13 disposed in the middle of the exhaust pipe 12 and opening/closing to start or stop the vacuum exhaust, and a pressure control valve14 disposed in the middle of the exhaust pipe 12 and opening/closing to control the pressure inside the process chamber 3.

A resistance heating element 15 to heat the process chamber 3 is wound around an outer wall of the process chamber 3. Further, an opening is formed in a sidewall of the process chamber 3, and a gate valve 16 that is opened/closed when the wafer W is carried into/out of the process chamber 3 is disposed along the opening with an O-ring 17 interposed therebetween.

Further, a purge gas supply system 18 to supply a purge gas such as, for example, a nitrogen gas that returns the pressure inside the process chamber 3 to the atmospheric pressure before the gate valve 16 is opened is connected to the sidewall of the process chamber 3.

The disc-shaped susceptor 19 to place the wafer W thereon is disposed at a position facing the showerhead 4 in the process chamber 3. The susceptor 19 is formed of, for example, aluminum nitride, silicon nitride, amorphous carbon, or composite carbon. The susceptor 19 is inserted in the process chamber 3 through an opening formed in the bottom of the process chamber 3. When the CVD apparatus 1 is in operation, a thin film of an insulative substance is formed on the film deposition surface of the wafer W while the wafer W is on an upper surface of the susceptor 19.

Inside the susceptor 19 or around the susceptor 19, a susceptor heater, for example, a resistance heating element or a heating lamp, for heating the susceptor 19 is disposed. In this embodiment, a case where a resistance heating element 20 is used as the susceptor heater will be described. The resistance heating element 20 is electrically connected to an external power source 21 disposed outside the process chamber 3.

Lifter holes 22 are bored in, for example, three places of the susceptor 19 to pass through the susceptor 19 in an up/down direction. Under the lifter holes 22, three lifter pins 23 movable in the up/down direction are disposed. When the lifter pins 23 are moved up/down by a not-shown hoisting/lowering device, the wafer W is placed on the susceptor 19 or is made apart from the susceptor 19.

The lifter pins 23 pass through the outer wall of the process chamber 3 and an extendible/contractible bellows 24 made of metal is disposed in a portion of the process chamber 3 through which the lifter pins 23 pass. Therefore, the inside of the process chamber 3 is kept airtight.

A control unit 25 is electrically connected to the process gas supply system 7, the cleaning gas supply system 9, the vacuum exhaust systems 10, the resistance heating elements 15, 20, and so on. The control unit 25 comprises: a computer 26 configured to controlling the operations of the CVD apparatus 1 based on a program to be described next; and a computer-readable recording medium 27 in which the program controlling the CVD apparatus 1 is recorded. The program comprises controlling the CVD apparatus 1 to execute a film deposition process (Step 1) and a cleaning process (Step 2) which will be described later.

The computer 26 stores the program recorded in the recording medium 27, for example, in its own memory. Then, the computer 26 reads the program from its own memory to control the CVD apparatus 1 based on the program, so that the CVD apparatus 1 executes the film deposition process and the cleaning process.

Examples of the recording medium 27 are a magnetic recording device, an optical disc, a magneto-optical recording medium, a semiconductor memory, and the like. Examples of the magnetic recording device are a hard disc device (HDD), a flexible disc (FD), a magnetic tape, and the like. Examples of the optical disc are a DVD (Digital Versatile Disc), a DVD-RAM (Random Access Memory), a CD-ROM (Compact Disc Read Only Memory), a CD-R (Recordable)/RW (ReWritable), and the like. Examples of the magneto-optical recording medium are a MO (Magneto-Optical Disc) and the like. Examples of the semiconductor memory are a ROM (Read Only Memory), a RAM (Random Access Memory), and the like.

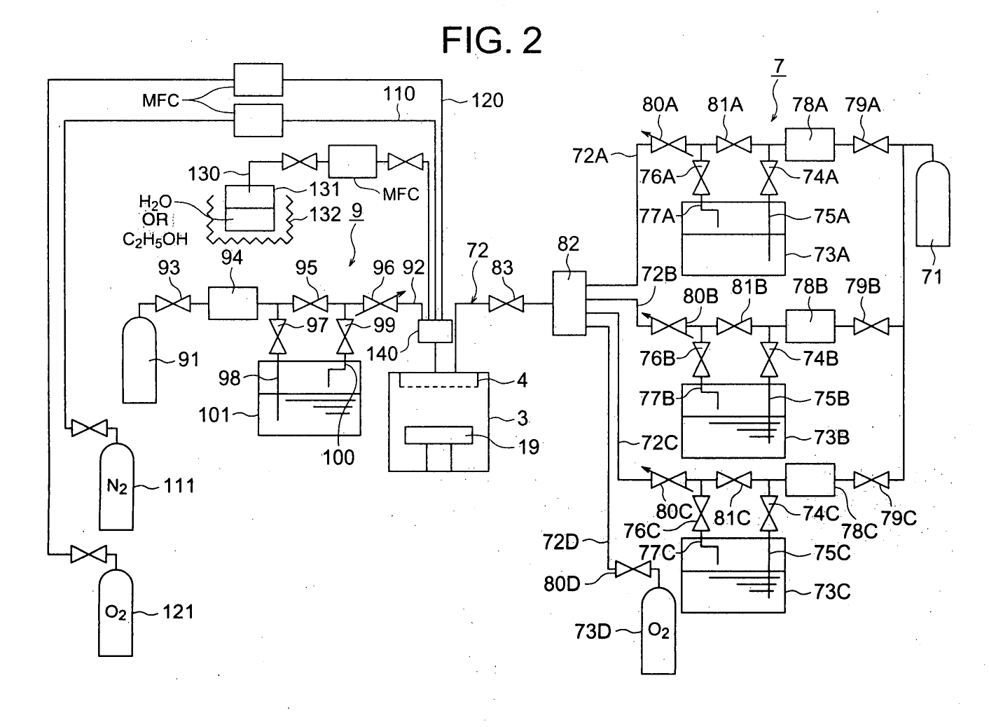

Next, the process gas supply system 7 and the cleaning gas supply system 9 of the CVD apparatus 1 according to this embodiment will be described. FIG. 2 is a view schematically showing the process gas supply system 7 and the cleaning gas supply system 9 of the CVD apparatus 1 according to this embodiment. As shown in FIG. 2, the process gas supply system 7 has a pipe 72 whose one end is connected to the top portion of the showerhead 4 and whose other end is connected to a carrier gas tank 71 containing a carrier gas such as an argon gas. In the description below, the showerhead 4 side is defined as a downstream side and the carrier gas tank 71 side is defined as an upstream side.

The pipe 72 passes through a later-described process gas mixer 82 to be branched off into a plurality of systems, for example, three systems. Source tanks 73A to 73C containing sources to compose the process gas, for example, a hafnium-based source, a zirconium-based source, and an aluminum-based source are connected to pipes 72A to 72C into which the pipe 72 is branched off, via first bypass pipes 75A to 75C and second bypass pipes 77A to 77C which will be described later.

The source tank 73A contains, for example, Hf(t-OC₄H₉)₄ or Hf[N(C₂H₅)₂]₄ as the hafnium-based source. The source tank 73B contains, for example, Zr(t-OC₄H₉)₄ or Zr[N(C₂H₅)₂]₄ as the zirconium-based source. The source tank 73C contains, for example, Al(OC₂H₅)₃ or Al(OCH₃)₃ as the aluminum-based source.

The first bypass pipes 75A to 75C having valves 74A to 74C in the middle thereof are connected to the pipes 72A to 72C and the source tanks 73A to 73C respectively. Further, the second bypass pipes 77A to 77C positioned on the downstream side of the first bypass pipes 75A to 75C and having valves 76A to 76C in the middle thereof are connected to the pipes 72A to 72C and the source tanks 73A to 73C respectively. When the valves 74A to 74C are opened and the carrier gas is supplied into the source tanks 73A to 73C through the first bypass pipes 75A to 75C to be bubbled, the sources contained in the source tanks 73A to 73C vaporize. These vaporized sources are introduced into the pipes 72A to 72C through the second bypass pipes 77A to 77C.

Mass flow controllers 78A to 78C and valves 79A to 79C are disposed on the upstream side of the first bypass pipes 75A to 75C in the pipes 72A to 72C. The flow rate of the carrier gas is adjusted by adjusting the mass flow controllers 78A to 78C.

Needle valves 80A to 80C are disposed on the downstream side of the second bypass pipes 77A to 77C in the pipes 72A to 72C. By adjusting the needle valves 80A to 80C, the pressures inside the source tanks 73A to 73C and supply amounts of the sources are adjusted.

Further, valves 81A and 81C are disposed between the first bypass pipes 75A to 75C and the second bypass pipes 77A to 77C in the pipes 72A to 72C.

The process gas mixer 82 is connected to the three-branched pipes 72A to 72C, so that it is possible to selectively supply one of the sources in the source tanks 73A to 73C or to supply a process gas in which the sources vaporized in the source tanks 73A to 73C are mixed at a predetermined ratio, as required.

An oxygen source 73D such as an oxygen cylinder is connected to the process gas mixer 82 via a pipe 72D. A valve 80D is disposed in the middle of the pipe 72D to adjust the flow rate of the oxygen.

A valve 83 is disposed on the downstream side of the process gas mixer 82 in the pipe 72. When the valve 83 is opened, the process gas composed of a single source or the mixed process gas is supplied to the showerhead 4 at a predetermined flow rate.

The cleaning gas supply system 9 adopts substantially the same structure as that of the process gas supply system 7 described above. Specifically, a valve 93, a mass flow controller 94, a valve 95, a needle valve 96, and a cleaning gas mixer 140 are disposed in the middle of a pipe 92 from the upstream side toward the downstream side. Here, the showerhead 4 side is defined as a downstream side and a side of a carrier gas tank 91 containing a carrier gas is defined as an upstream side.

Further, a first bypass pipe 98 having a valve 97 disposed in the middle thereof is connected to the pipe 92 at a position between the mass flow controller 94 and the valve 95, and a second bypass pipe 100 having a valve 99 in the middle thereof is connected to the pipe 92 at a position between the valve 95 and the needle valve 96.

A water or ethanol supply system 130, a N₂ supply system 110, and an O₂ supply system 120 are connected to the cleaning gas mixer 140. Water or ethanol in the water or ethanol tank 131, N₂ in the N₂ cylinder 111, and O₂ in the O₂ cylinder 121 are mixed at a predetermined ratio to be supplied as a mixed cleaning gas. Around the water or ethanol tank 131, a heater 132 for heating and vaporizing the water or ethanol is disposed.

A Hhfac tank 101 containing hexafluoroacetylacetone (Hhfac) as β-diketone is connected to the first and second bypass pipes 98, 100. Here, as the β-diketone, β-diketone such as, for example, Hhfac in which an alkyl bonded with a carbonyl has a halogen atom is preferably used. Such β-diketone is preferable because a halogen atom is high in inductive effect and this effect reduces electron density of an oxygen atom of the carbonyl, so that a hydrogen atom bonded with the oxygen atom is easily dissociated as a hydrogen ion. Reactivity is higher as the dissociation more easily occurs.

When the valve 97 of the first bypass pipe 98 is opened and the carrier gas is supplied from the first bypass pipe 98 into the Hhfac tank 101 for bubbling, the Hhfac contained in the Hhfac tank 101 vaporizes. The vaporized Hhfac is sent to the cleaning gas mixer 140 through the second bypass pipe 100 and the pipe 92 to be mixed with O₂, N₂, and water or ethanol at a predetermined ratio, and the resultant gas is supplied into the showerhead 4 as the cleaning gas.

Next, the flows of the film deposition process performed in the CVD apparatus 1 and the cleaning process of the CVD apparatus 1 according to this embodiment will be described. It is assumed that the vacuum pumps 11 are in operation during the film deposition process and the cleaning process.

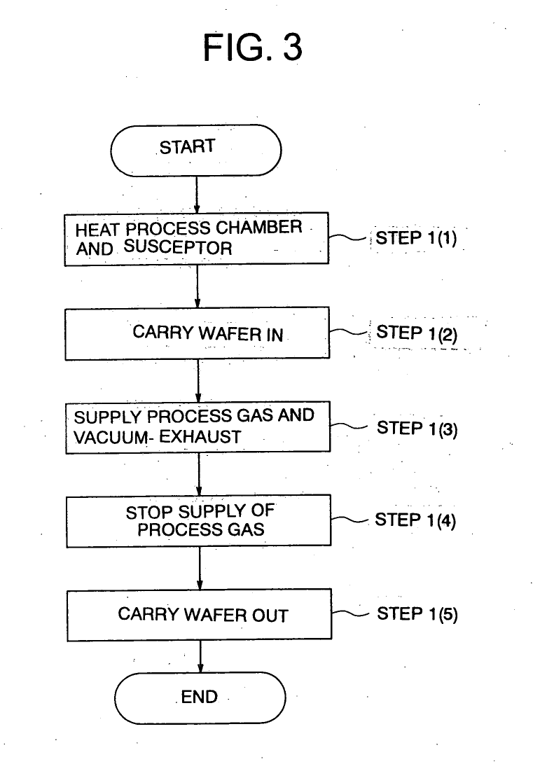

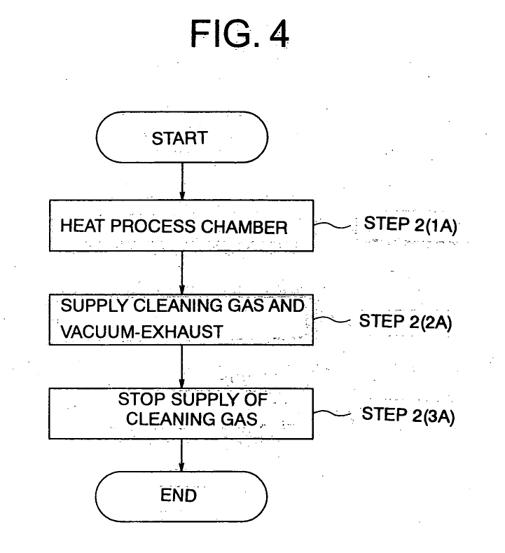

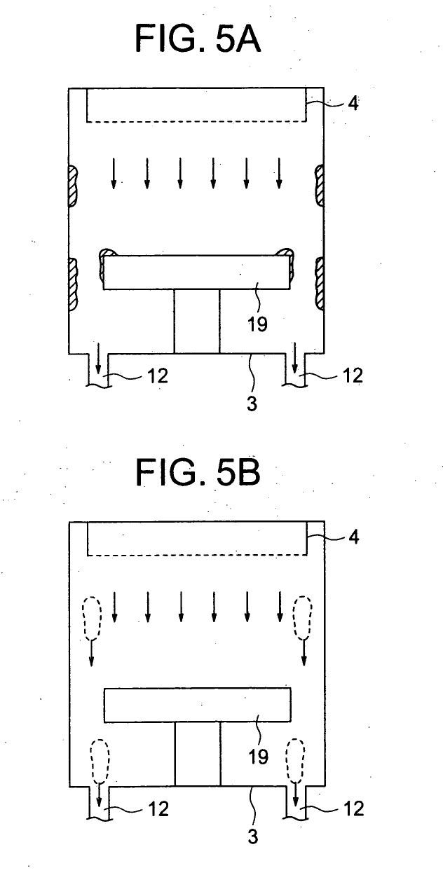

FIG. 3 is a flowchart showing the flow of the film deposition performed in the CVD apparatus 1 according to this embodiment, and FIG. 4 is a flowchart showing the flow of the cleaning of the CVD apparatus 1 according to this embodiment. FIG. 5A and FIG. 5B are vertical cross-sectional views schematically showing the cleaning process of the CVD apparatus 1 according to this embodiment.

First, the film deposition process performed in the CVD apparatus 1 will be described (Step 1). Note that the program for the CVD apparatus 1 to execute Step 1(1) to Step 1(5), which will be described below, is recorded in the recording medium 27. The computer 26 reads the program recorded in the recording medium 27 and the computer 26 controls the CVD apparatus 1 based on the program, so that these steps are executed by the CVD apparatus 1.

First, the not-shown external power source supplies electric current to the resistance heating element 15 and the external power source 21 supplies electric current to the resistance heating element 20 to heat the process chamber 3 and the susceptor 19 to a film deposition temperature (Step 1(1)).

After the process chamber 3 and the susceptor 19 are heated to the film deposition temperature, the gate valve 16 is opened and a not-shown transfer arm carries a wafer W on which a thin film of an insulative substance is not formed into the process chamber 3 to place the wafer W on the lifter pins 23 which have been lifted. Thereafter, the lifter pins 23 move down to place the wafer W on the susceptor 19 (Step 1(2)).

After the wafer W is placed on the susceptor 19, the valve 79A, the valve 74A, the valve 76A, the needle valves 80A, 80D, and the valve 83 are opened, and the carrier gas is supplied into the source tank 73A at a flow rate adjusted by the mass flow controller 78A. The carrier gas bubbles the source in the source tank 73A to vaporize the source. The vaporized sources are introduced to the process gas mixer 82 to be mixed therein, and thereafter the mixed gas is supplied into the showerhead 4 as the process gas. The process gas is discharged from the discharge ports 6 of the showerhead 4, so that the formation of the thin film of the insulative substance is started on the film deposition surface of the wafer W. When the film deposition is to be started, the shutoff valves 13 are opened to vacuum-exhaust the inside of the process chamber 4 (Step 1(3)).

Here, when the thin film of the insulative substance is formed on the wafer W, the insulative substance also adheres to the inside of the process chamber 3, specifically, for example, an inner wall of the process chamber 3 and the susceptor 19.

After the thin film of the insulative substance is formed on the wafer W, the valve 79A, the valve 74A, the valve 76A, the needle valves 80A, 80D, and the valve 83 are closed to stop the supply of the process gas, thereby finishing the formation of the thin film of the insulative substance (Step 1(4)).

Thereafter, the lifter pins 23 move up to bring the wafer W apart from the susceptor 19, and the gate valve 16 is opened while the purge gas is supplied. Then, the wafer W on which the thin film of the insulative substance is formed is carried out of the process chamber 3 by the not-shown transfer arm (Step 1(5)).

Next, the cleaning process of the inside of the process chamber 3 will be described (Step 2). Note that the program for the CVD apparatus 1 to execute Step 2(1A) to Step 2(3A), which will be described below, is recorded in the recording medium 27. The computer 26 reads the program recorded in the recording medium 27 and the computer 26 controls the CVD apparatus 1 based on the program, so that these steps are executed by the CVD apparatus 1.

After the wafer W on which the thin film of the insulative substance is formed is carried out of the process chamber 3, the resistance heating element 15 heats the process chamber 3 to not lower than 300° C. nor higher than 450° C., preferably, not lower than 350° C. nor higher than 425° C. (Step 2(1A)).

After the process chamber 3 is heated to not lower than 300° C. nor higher than 450° C., the valve 93, the valve 97, the valve 99, and the needle valve 96 are opened, and the carrier gas is supplied into the Hhfac tank 101 while the flow rate of the carrier gas is adjusted by the mass flow controller 94. This carrier gas bubbles Hhfac in the Hhfac tank 101 to vaporize the Hhfac. The Hhfac vaporized by the bubbling is mixed with water or ethanol, N₂, and O₂ in the cleaning gas mixer 140, and the resultant gas is supplied as the cleaning gas into the process chamber 3 through the showerhead 4. This is the start of the cleaning of the inside of the process chamber 3. Further, in this embodiment, the shutoff valves 13 are opened for vacuum exhaust during the cleaning (Step 2(2A)). Here, the pressure inside the process chamber 3 during the cleaning is kept at not lower than 1.33×10³ Pa nor higher than 1.33×10⁴ Pa. More preferably, the pressure inside the process chamber 3 during the cleaning is kept at not lower than 3.33×10³ Pa nor higher than 9.96×10³ Pa.

Phenomena occurring during the cleaning will be specifically described. First, the Hhfac contained in the cleaning gas disperses in the process chamber 3 to come into contact with the insulative substance adhering to the inside of the process chamber 3. When the Hhfac comes in contact with the insulative substance, the Hhfac and the insulative substance react with each other to form a complex of a substance composing the insulative substance as shown in FIG. 5A. Further, the inside of the process chamber 3 is vacuum-exhausted because the shutoff valves 13 are open. Consequently, the complex easily vaporizes to become apart from the inner wall of the process chamber 3 and from the susceptor 19. Moreover, the complex that has been apart therefrom is quickly discharged outside the process chamber 3 through the exhaust pipes 12 as shown in FIG. 5B, so that the insulative substance is removed from the inside of the process chamber 3.

After the insulative substance adhering to the inside of the process chamber 3 is fully removed, the valve 93, the valve 97, the valve 99, and the needle valve 96 are closed to stop the supply of the cleaning gas, thereby finishing the cleaning of the inside of the process chamber (Step 2(3A)).

This embodiment can provide a sufficient cleaning effect since the cleaning is performed while the processing chamber 3 is under the temperature which has been raised to not lower than 300° C. nor higher than 450° C. Specifically, when the cleaning is performed while the process chamber 3 is under the temperature which has been raised to not lower than 300° C. nor higher than 450° C., the decomposition of the Hhfac contained in the cleaning gas is inhibited. Consequently, the insulative substance and the Hhfac easily react with each other, so that the complex of the substance composing the insulative substance is easily formed. Therefore, a sufficient cleaning effect can be obtained.

In this embodiment, the pressure inside the process chamber 3 is kept at not lower than 1.33×10³ Pa nor higher than 1.33×10⁴ Pa during the cleaning, so that a sufficient cleaning effect can be obtained. Specifically, when the pressure inside the process chamber 3 is kept at not lower than 1.33×10³ Pa nor higher than 1.33×10⁴ Pa during the cleaning, the complex of the substance composing the insulative substance easily vaporizes. Moreover, the frequency of the collision of the Hhfac with the insulative substrate is increased, so that the complex of the substance composing the insulative substance is easily formed. Therefore, a sufficient cleaning effect can be obtained.

In this embodiment, since the cleaning gas contains O₂, a sufficient cleaning effect can be obtained.

In this embodiment, since the shutoff valves 13 are opened for vacuum exhaust during the cleaning, the complex of the substance composing the insulative substance can be vaporized immediately after being produced.

In this embodiment, since the insulative substance is directly complexed by Hhfac, the number of processes for the cleaning is small and it is possible to easily remove the insulative substance adhering to the inside of the process chamber 3 in a short time.

In this embodiment, since Hhfac easily reacting with the insulative substance is used as β-diketone, it is possible to more surely remove the insulative substance from the process chamber 3.

### EXAMPLE 1

Hereinafter, an example 1 will be described. In this example, the CVD apparatus 1 described in the first embodiment was used, and the removal rate in the use of HfO₂ as an insulative substance and the removal rate in the use of Al₂O₃ as an insulative substance were measured under varied temperatures. Here, in this example, HfO₂ or Al₂O₃ adhering to the inner wall of the CVD apparatus 1 and the susceptor 19 was not removed, but a wafer W on which a thin film of HfO₂ or Al₂O₃ was formed was placed on the susceptor 19 in the CVD apparatus 1 and a thin film of HfO₂ or Al₂O₃ formed on the wafer W was removed by a cleaning gas.

Hhfac, N₂, and O₂ were supplied into the process chamber 3 at flow rates of 375 sccm, 20 sccm, and 50 sccm respectively. Note that the cleaning gas contained water whose contents was 1000 ppm. Further, the pressure control valves 14 were adjusted to keep the pressure inside the processing chamber 3 at about 6.65×10³ Pa during the cleaning.

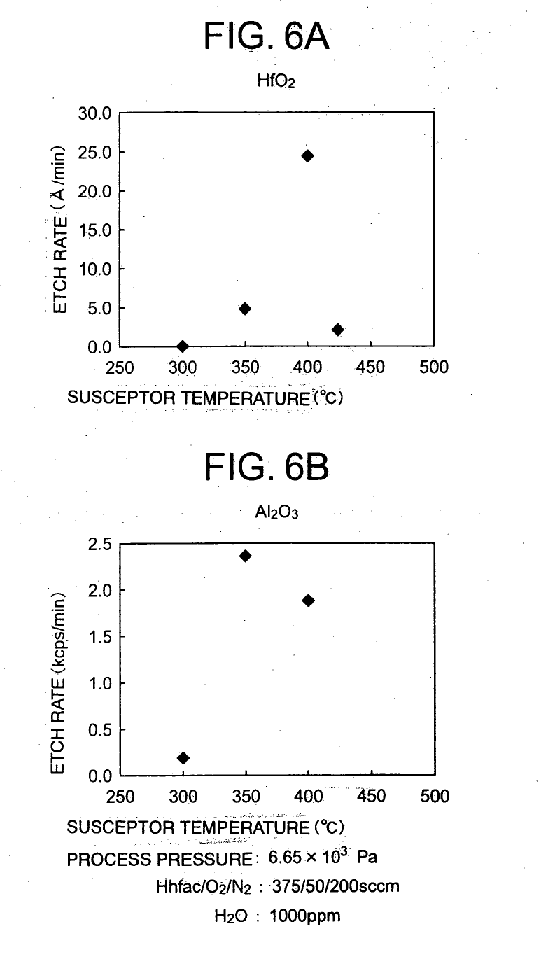

The cleaning was conducted for 10 minutes under varied temperatures while the inside of the process chamber 3 was kept in the above-described state. FIG. 6A is a graph showing the correlation between the temperature of the susceptor 19 of the CVD apparatus 1 and the etch rate of HfO₂ formed on the wafer W, according to this example, and FIG. 6B is a graph showing the correlation between the temperature of the susceptor 19 of the CVD apparatus 1 and the etch rate of Al₂O₃ formed on the wafer W, according to this example.

As shown in FIG. 6A, it has been confirmed that the etch rate of HfO₂ rises in a temperature range from 350° C. to 400° C. Further, as shown in FIG. 6B, it has been confirmed that the etch rate of Al₂O₃ rises to reach its peak in a temperature range from 300° C. to 400° C. Incidentally, the etch rate in FIG. 6B is represented using kcps (kilo counts per second) which represents intensity of X-ray fluorescence proportional to the number of metal atoms in fluorescent X-ray analysis, instead of a physical film thickness.

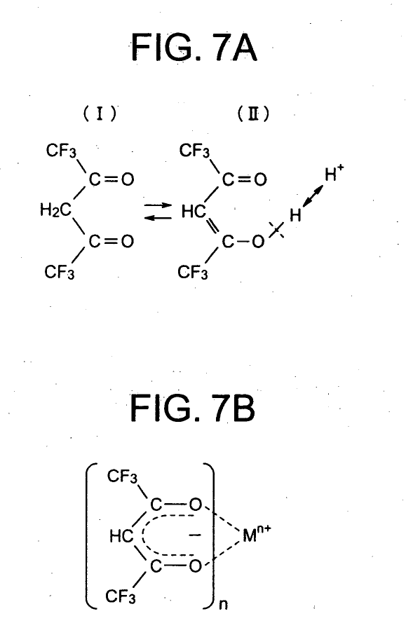

FIG. 7A is a diagram schematically showing a chemical structure of Hhfac, and FIG. 7B is a diagram schematically showing a chemical structure of a metal complex formed by Hhfac. β-diketone such as Hhfac has tautomerism. Therefore, Hhfac can take two structures of a structure I and a structure II as shown in FIG. 7A.

As a result, shared electrons are delocalized in C═O bond and C—C bond. This causes easy separation of O—H bond of the structure II. If a positively charged atom such as a metal atom M exists near Hhfac in this state, it is thought that Hhfac with the structure II in which the O—H bond is separated coordinates to form a complex as in FIG. 7B. It is thought that since a state of a complex that is formed when a plurality of Hhfac coordinate to the metal atom M is produced, the complex is easily removed from the inner chamber. Incidentally, it is thought that β-diketone, not limited to Hhfac, causes such a reaction.

As described above, when Hhfac is used for cleaning the process chamber 3 following the method according to the first embodiment described above, the process chamber 3 can be sufficiently cleaned under a feasible temperature range of not lower than 300° C. nor higher than 450° C.

### COMPARATIVE EXAMPLE 1

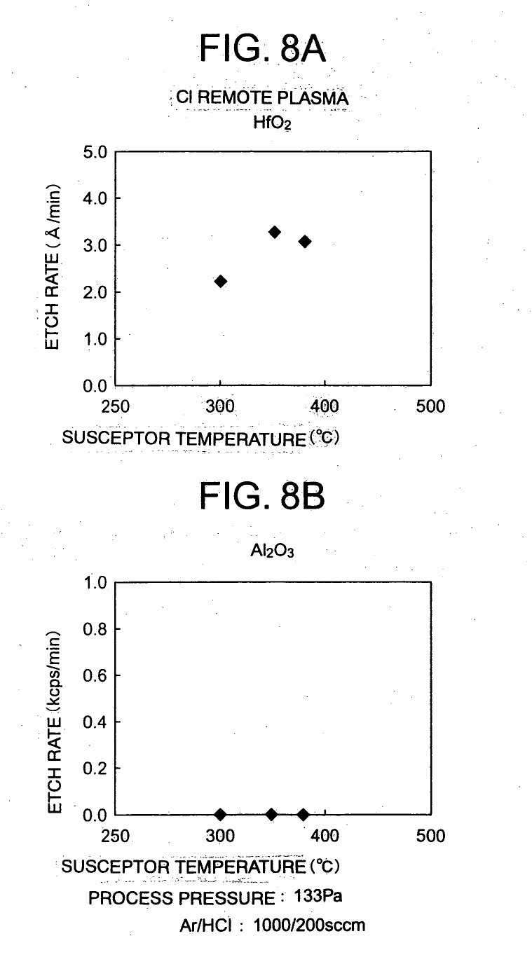

A comparative example 1 will be described below. In this comparative example, the same apparatus as that used in the example 1 described above was used, and a cleaning experiment was conducted under the same conditions as those of the example 1 described above except that Cl remote plasma was used instead of Hhfac. FIG. 8A and FIG. 8B show the results. FIG. 8A is a graph showing the correlation between the temperature of the susceptor 19 of the CVD apparatus 1 and the etch rate of HfO₂ formed on the wafer W, according to this comparative example, and FIG. 8B is a graph showing the correlation between the temperature of the susceptor 19 of the CVD apparatus 1 and the etch rate of Al₂O₃ formed on the wafer W, according to this comparative example.

As shown in FIG. 8A, it has been confirmed that the etch rate of HfO₂ rises to reach its peak in a temperature range from 300° C. to 400° C., but it has been confirmed that the cleaning rate is lower than that when Hhfac is used.

On the other hand, as seen in the result in FIG. 8B, the etch rate of Al₂O₃ is extremely low in a feasible temperature range of not lower than 300° C. nor higher than 400° C. No sign showing the improvement in the etch rate is observed even when the temperature is raised to 400° C. or higher. It is inferred from these results that it is difficult to clean off Al₂O₃ by using Cl remote plasma.

As described above, it has been confirmed that it is difficult to clean off the insulative substance by using Cl remote plasma.

### COMPARATIVE EXAMPLE 2

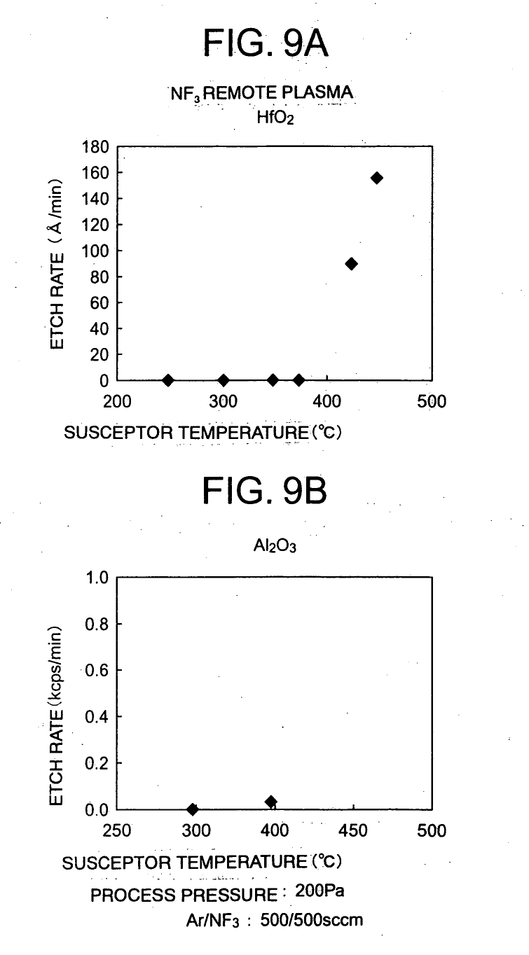

Hereinafter, a comparative example 2 will be described. In this comparative example, the same apparatus as that used in the example 1 described above was used, and a cleaning experiment was conducted under the same conditions as those of the example 1 described above except that NF₃ remote plasma was used instead of Hhfac. FIG. 9A and FIG. 9B show the results. FIG. 9A is a graph showing the correlation between the temperature of the susceptor 19 of the CVD apparatus 1 and the etch rate of HfO₂ formed on the wafer W, according to this comparative example, and FIG. 9B is a graph showing the correlation between the temperature of the susceptor 19 of the CVD apparatus 1 and the etch rate of Al₂O₃ formed on the wafer W, according to this comparative example.

As shown in FIG. 9A, it has been confirmed that the etch rate of HfO₂ shows an increasing tendency in a temperature range of 400° C. to 500° C. Judging from this result, it is inferred that it is necessary to raise the temperature of the inside of the chamber to 400° C. or higher in order to clean off HfO₂ by using NF₃ remote plasma.

On the other hand, as is seen in the result in FIG. 9B, the etch rate of Al₂O₃ is extremely low in a feasible temperature range of not lower than 300° C. nor higher than 400° C. No sign of the improvement in the etch rate is observed even when the temperature is raised to a high temperature of 400° C. or higher. It is inferred from this result that it is difficult to clean off Al₂O₃ by using NF₃ remote plasma.

As described above, it is necessary to keep the inside of the chamber at a high temperature of 400° C. or higher when NF₃ remote plasma is used for the cleaning, but it has been confirmed that there is some case where an insulative substance cannot be cleaned off even at the high temperature of 400° C. or higher, depending on the kind of the insulative substance. In other words, it has been confirmed that the cleaning in a feasible temperature range of not lower than 300° C. to nor higher than 400° C. is difficult.

### EXAMPLE 2

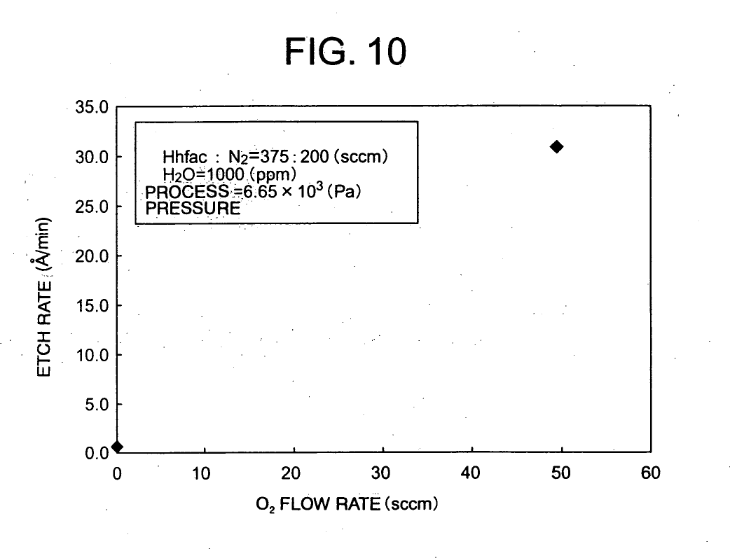

Hereinafter, an example 2 of the present invention will be described. In this example, the same apparatus as that used in the example 1 described above was used and the correlation between the flow rate of O₂ contained in the cleaning gas and the etch rate was studied. Hhfac and N₂ were mixed at a ratio of Hhfac:N₂=375:200 (sccm). The water content in this mixed gas was 1000 ppm. This mixed gas was supplied into the chamber at a pressure of 6.65×10³ Pa, and O₂ was supplied into the chamber. The etch rate of a HfO₂ film was measured while the flow rate of O₂ was gradually increased. FIG. 10 shows the result.

FIG. 10 is a graph in which the flow rate of O₂ is taken on the horizontal axis and the etch rate of the HfO₂ film is plotted on the vertical axis. AS is apparent from the graph in FIG. 10, it was observed that the etch rate of the HfO₂ film remarkably improves when O₂ is supplied at a flow rate of 50 sccm compared with a case where O₂ is not supplied. It is inferred from this result that the cleaning gas preferably contains O₂.

### EXAMPLE 3

Hereinafter, an example 3 of the present invention will be described. In this example, the same apparatus as that used in the example 1 described above was used, and the optimum condition for cleaning was studied. A mixed gas of Hhfac, O₂, and N₂ was used as a cleaning gas. The water content in this mixed gas was 1000 ppm.

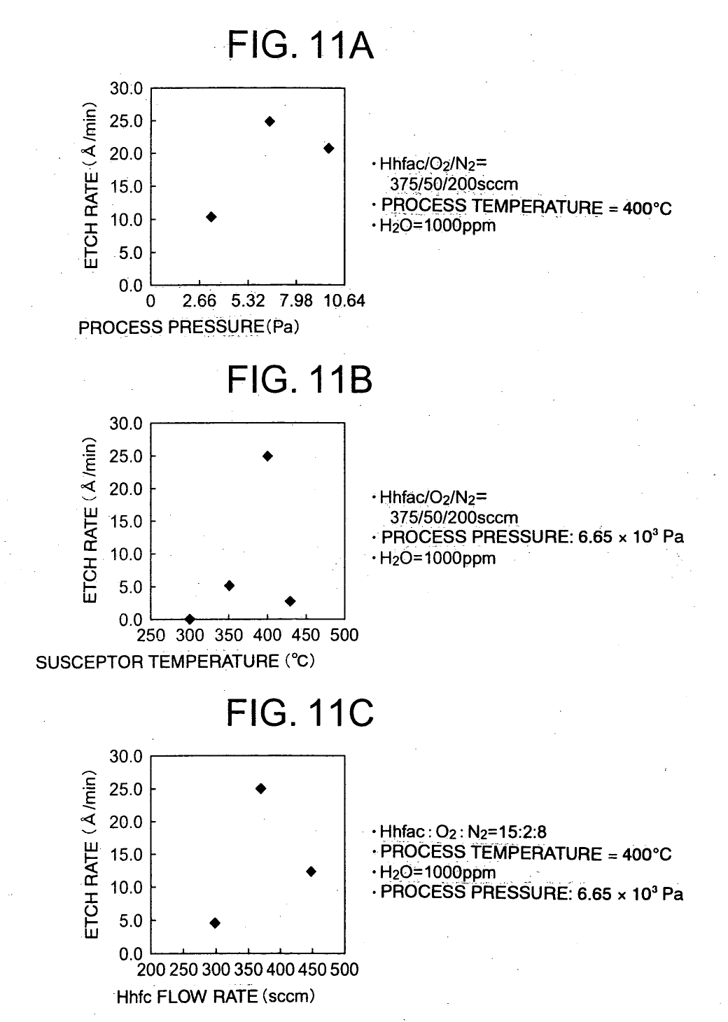

The mixed gas was supplied into the chamber, and it was studied how changes in the process pressure, process temperature, and flow rate of Hhfac influence the process result. FIG. 11A to FIG. 11C show the results.

FIG. 11A is a graph in which the process pressure of the cleaning gas is taken on the horizontal axis and the etch rate of a HfO₂ film is plotted on the vertical axis. The process conditions were such that the flow rate ratio of Hhfac/O₂/N₂ was 375/50/200 (sccm), the process temperature was 400° C., and the water content was 1000 ppm.

As is apparent from the graph in FIG. 11A, the etch rate reaches its peak when the process pressure of the cleaning gas is about 6.65×10³ Pa. The reason for this is thought to be that the frequency of the collision of Hhfac in the cleaning gas with HfO₂ and the elimination speed of the produced complex reach the respective peaks when the process pressure of the cleaning gas is about 6.65×10³ Pa.

FIG. 11B is a graph in which the process temperature of the cleaning gas is taken on the horizontal axis and the etch rate of a HfO₂ film is plotted on the vertical axis. The process conditions were such that the flow rate ratio of Hhfac/O₂/N₂ was 375/50/200 (sccm), the process pressure was 6.65×10³ Pa, and the water content was 1000 ppm.

As is apparent from the graph in FIG. 11B, the etch rate reaches its peak when the process temperature is about 400° C. The reason for this is thought to be that a heat quantity of about 400° C. is required for Hhfac in the cleaning gas to coordinate to a Hf atom.

On the other hand, the etch rate drastically lowers when the process temperature reaches about 425° C. The reason for this is thought to be that Hhfac itself decomposes due to the heat when the process temperature reaches 425° C.

FIG. 11C is a graph in which the flow rate of Hhfac in the cleaning gas is taken on the horizontal axis and the etch rate of a HfO₂ film is plotted on the vertical axis. The process conditions were such that the composition ratio of Hhfac:O₂: N₂ was 375:50:20, the process temperature was 400° C., and the water content was 1000 ppm.

As is apparent from the graph in FIG. 1C, the etch rate reaches its peak when the flow rate of Hhfac in the cleaning gas is about 375 sccm.

On the other hand, the etch rate drastically lowers when the flow rate of Hhfac in the cleaning gas reaches about 450 sccm. The reason for this is thought to be that the surface temperature of an object to be processed drops when the flow rate of Hhfac reaches about 450 sccm or higher.

### EXAMPLE 4

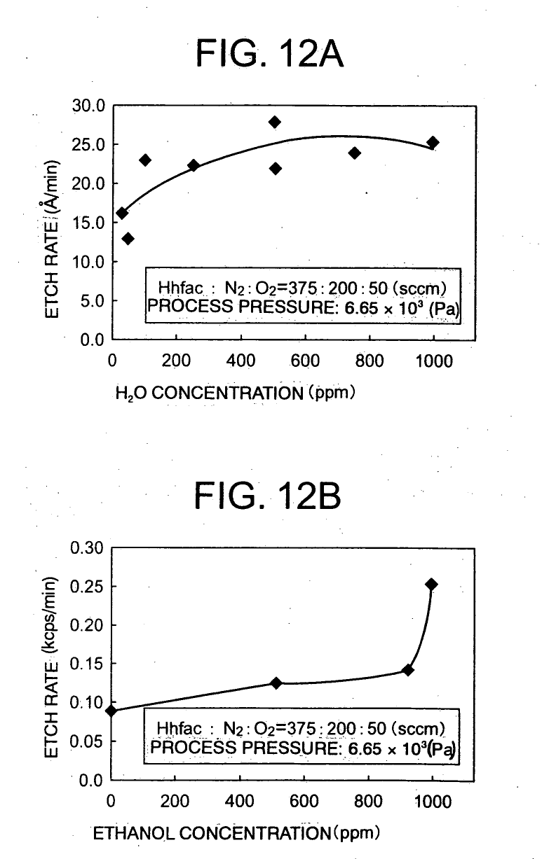

Hereinafter, an example 4 of the present invention will be described. In this example, the same apparatus as that used in the example 1 described above was used and the influences of water and so on contained in the cleaning gas were studied. FIG. 12A and FIG. 12B show the results. FIG. 12A is a graph in which the concentration of water in the cleaning gas is taken on the horizontal axis and the etch rate of a Hfo₂ film is plotted on the vertical axis. FIG. 12B is a graph in which the concentration of ethanol in the cleaning gas is taken on the horizontal axis and the etch rate of a HfO₂ film is plotted on the vertical axis.

The process conditions were such that the flow rate ratio of Hhfac/N₂/O₂ was 375/200/50 (sccm) and the process pressure was 6.65×10³ Pa. As is apparent from FIG. 12A, the etch rate shows a gradual increase when the concentration of water is in a range from 0 ppm to about 600 ppm, and reaches its peak when the water concentration is about 700 ppm. Further, as is apparent from FIG. 12B, the rise of the etch rate was confirmed when the concentration of the ethanol was 1000 ppm.

It is inferred from these results that the concentration of water or ethanol contained in the cleaning gas, though depending on the kind of a substance to be cleaned, preferably falls approximately in a range of not lower than 50 ppm nor higher than 5000 ppm, and more preferably in a range not lower than 100 ppm nor higher than 1000 ppm.

### Second Embodiment

Hereinafter, a second embodiment of the present invention will be described. In this embodiment and an embodiment to follow, the same contents as those in a preceding embodiment will not be described.

In this embodiment, after a cleaning gas is stored in the process chamber 3 and an insulative substance adhering to the inside of the process chamber 3 is complexed, the inside of the process chamber 3 is vacuum-exhausted.

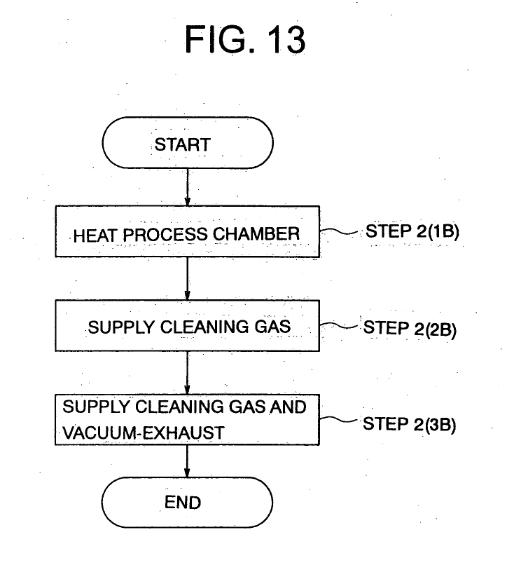

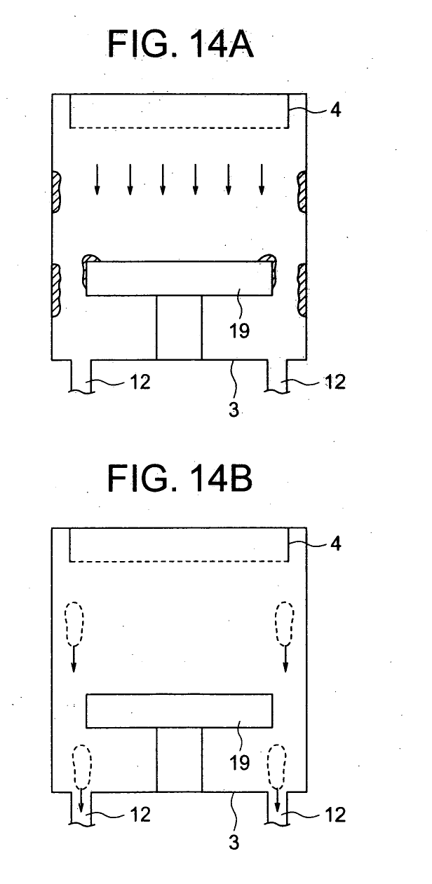

FIG. 13 is a flowchart showing the flow of cleaning of the CVD apparatus 1 according to this embodiment, and FIG. 14A and FIG. 14B are vertical cross-sectional views schematically showing a cleaning process of the CVD apparatus 1 according to this embodiment.

The cleaning process of this embodiment is executed by the computer 26 reading a program recorded in the recording medium 27 and controlling the CVD apparatus 1 based on the program, as in the first embodiment. Note that a program for the CVD apparatus 1 to execute Step 2(1B) to Step 2(3B), which will be described below, is recorded in the recording medium 27.

First, after a wafer W on which a thin film of an insulative substance is formed is carried out of the process chamber 3, the resistance heating element 15 wound around the outer wall of the process chamber 3 heats the process chamber 3 (Step 2(1B)).

After the process chamber 3 is heated, the valve 93, the valve 97, the valve 99, and the needle valve 96 are opened to supply the cleaning gas into the process chamber 3 (Step 2(2B)).

When the cleaning gas disperses in the process chamber 3 to come into contact with the insulative substance adhering to the inside of the process chamber 3, a complex of a substance composing the insulative substance is formed. Here in this embodiment, the shutoff valves 13 are closed, and as shown in FIG. 14A, the cleaning gas supplied into the process chamber 3 is stored without any vacuum exhaust.

After the complex is fully formed, the valve 93, the valve 97, the valve 99, and the needle valve 96 are closed to stop the supply of a carrier gas and a cleaning gas, and the shutoff valves 13 are opened to vacuum-exhaust the inside of the process chamber 3 (Step 2(3B)). The complex vaporizes due to this vacuum exhaust to be apart from the inner wall of the process chamber 3 and the susceptor 19 as shown in FIG. 14B and to be quickly discharged out of the process chamber 3 through the exhaust pipes 12. Thereafter, the complex is fully discharged out of the process chamber 3 to finish the cleaning.

As described above, in this embodiment, the inside of the process chamber 3 is vacuum-exhausted after the cleaning gas is stored in the process chamber 3 and the complex of the substance composing the insulative substance is formed. Therefore, the cleaning gas disperses to every corner of the inside of the process chamber 3, which can provide a unique effect that the insulative substance adhering to the inside of the process chamber 3 can be more surely removed. In addition, since the inside of the process chamber 3 is vacuum-exhausted after the cleaning gas is stored therein, it is possible to save the cleaning gas to realize cost reduction.

### Third Embodiment

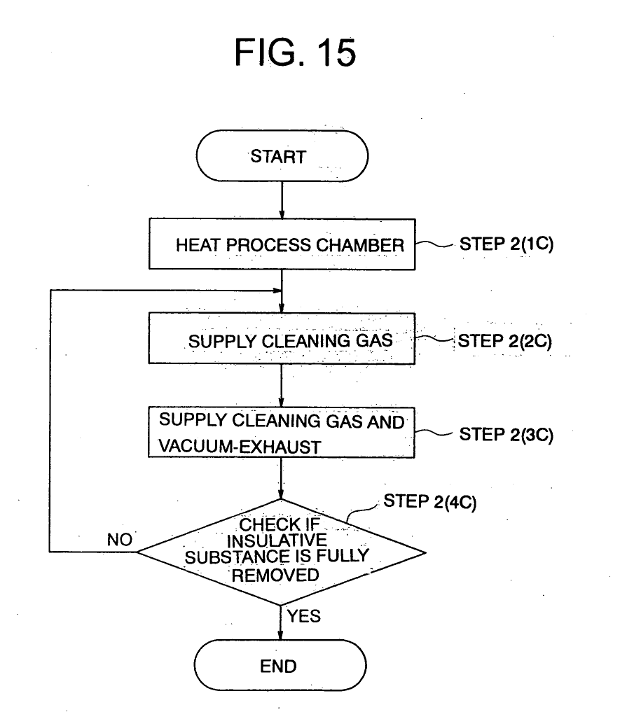

Hereinafter, a third embodiment will be described. In this embodiment, a series of processes of storing a cleaning gas in the process chamber 3 to form a complex of a substance composing an insulative substance, and thereafter vacuum-exhausting the inside of the process chamber 3 are intermittently repeated. FIG. 15 is a flowchart showing the flow of cleaning of the CVD apparatus according to this embodiment.

The cleaning process of this embodiment is executed by the computer 26 reading a program recorded in the recording medium 27 and controlling the CVD apparatus 1 based on the program, as in the first embodiment. Note that a program for the CVD apparatus 1 to execute Step 2(1C) to Step 2(4C), which will be described below, is recorded in the recording medium 27.

As shown in FIG. 15, after a wafer W on which a thin film of the insulative substance is formed is carried out of the process chamber 3, the resistance heating element 15 heats the process chamber 3 (Step 2(1C)).

After the process chamber 3 is heated, the valve 93, the valve 97, the valve 99, and the needle valve 96 are opened and the cleaning gas is supplied into the process chamber 3 to form the complex of the substance composing the insulative substance (Step 2(2C)). After the complex is fully formed, the valve 93, the valve 97, the valve 99, and the needle valve 96 are closed to stop the supply of the cleaning gas, and the shutoff valves 13 are opened to vacuum-exhaust the inside of the process chamber 3 (Step 2(3C)).

After the complex is fully discharged out of the process chamber 3, an amount of the insulative substance adhering to the inside of the process chamber 3 is checked (Step 2 (4C)). This check work can be conducted by directly checking the adhesion state of the insulative substance to the inner wall of the process chamber 3 or by checking a residual amount of a thin film of the insulative substance formed on a monitoring wafer. Alternatively, the amount of the adhering insulative substance can be checked by infrared spectroscopy, using a not-shown observation window provided in the process chamber 3. When the result of checking the amount of the insulative substance adhering to the inside of the process chamber 3 shows that the insulative substance adhering to the inside of the process chamber 3 is fully removed, the cleaning is finished.

On the other hand, when the result of checking the amount of the insulative substance adhering to the inside of the process chamber 3 shows that the insulative substance adhering to the inside of the process chamber 3 is not fully removed, the operations of Step 2 (2C) to Step 2 (4C) described above are repeated and the cleaning operation is continued until there finally remains no insulative substance adhering to the inside of the process chamber 3.

As described above, in this embodiment, a series of the processes of storing the cleaning gas in the process chamber 3 to form the complex of the substance composing the insulative substance and thereafter vacuum-exhausting the inside of the process chamber 3 is intermittently repeated, resulting in the complete formation and discharge of the complex. This can provide a unique effect that the insulative substance adhering to the inside of the process chamber 3 can be removed efficiently.

It should be noted that the present invention is not limited to the contents described in the above first to third embodiments. The structure, materials, arrangement of the members, and so on can be appropriately changed without departing from the spirit of the present invention. For example, in describing the first to third embodiments, the CVD apparatus 1 utilizing heat is used as a CVD apparatus. However, a CVD apparatus utilizing plasma is also usable.

In describing the first to third embodiments, the CVD apparatus 1 is used as a substrate processing apparatus. However, a film deposition apparatus such as a physical vapor deposition apparatus (PVD apparatus) and a plating apparatus, an etching apparatus, or a chemical mechanical polishing apparatus (CMP apparatus) are also usable. Moreover, in describing the first to third embodiments, the wafer W is used as a substrate. However, a LCD glass substrate for liquid crystal is also usable.

1. A method of cleaning a substrate processing apparatus, comprising:
supplying a cleaning gas containing β-diketone and one of water and alcohol into a process chamber of the substrate processing apparatus having an insulative substance adhering to an inner part thereof, while the process chamber is set under a temperature that has been raised-to not lower than 300° C. nor higher than 450° C., to cause a reaction of the insulative substance and the β-diketone contained in the cleaning gas, thereby forming a complex of a substance composing the insulative substance; and
discharging the complex out of the process-chamber.

2. The method of cleaning the substrate processing apparatus as set forth in claim 1, wherein a content-ratio of one of the water and the alcohol in the cleaning gas is not lower than 50 ppm nor higher than 5000 ppm.

3. The method of cleaning the substrate processing apparatus as set forth in claim 1, wherein the cleaning gas contains an oxygen gas.

4. The method of cleaning the substrate processing apparatus as set forth in claim 1, wherein the β-diketone is a substance represented as R¹ (CO)CH₂ (CO)R², R¹ and R² independently are an alkyl and a haloalkyl.

5. The method of cleaning the substrate processing apparatus as set forth in claim 1, wherein the β-diketone is hexafluoroacetylacetone.

6. A method of cleaning a substrate processing apparatus, comprising:
supplying a cleaning gas containing hexafluoroacetylacetone into a process chamber of the substrate processing apparatus having an insulative substance adhering to an inner part thereof, while the process chamber is set under a temperature that has been raised to not lower than 300° C. nor higher than 450° C. and the inner part of the process chamber is kept at a pressure of not lower than 1.33×10³ Pa nor higher than 1.33×10⁴ Pa, to cause a reaction of the insulative substance and the hexafluoroacetylacetone contained in the cleaning gas, thereby forming a complex of a substance composing the insulative substance; and
discharging the complex out of the process chamber.

7. The method of cleaning the substrate processing apparatus as set forth in claim 6, wherein said forming of the complex and said discharge of the complex are alternately repeated.

8. The method of cleaning the substrate processing apparatus as set forth in claim 6, wherein the insulative substance is a high-dielectric substance containing at least one kind out of aluminum (Al), zirconium (Zr), hafnium (Hf), lanthanum (La), yttrium (Y), praseodymium (Pr), and cerium (Ce).

9. A method of cleaning a substrate processing apparatus, comprising:
supplying a cleaning gas containing β-diketone and oxygen into a process chamber of the substrate processing apparatus having an insulative substance adhering to an inner part thereof, to cause a reaction of the insulative substance and the β-diketone, thereby forming a complex of a substance composing the insulative substance; and
discharging the complex out of the process chamber.

10. The method of cleaning the substrate processing apparatus as set forth in claim 9, wherein said forming of the complex and said discharge of the complex are alternately repeated.

11. The method of cleaning the substrate processing apparatus as set forth in claim 9, wherein the insulative substance is a high-dielectric substance containing at least one kind out of aluminum (Al), zirconium (Zr), hafnium (Hf), lanthanum (La), yttrium (Y), praseodymium (Pr), and cerium (Ce).

12. The method of cleaning the substrate processing apparatus as set forth in claim 9, wherein the β-diketone is a substance represented as R¹(CO)CH₂(CO)R², R¹ and R² independently are an alkyl and a haloalkyl.

13. The method of cleaning the substrate processing apparatus as set forth in claim 9, wherein the β-diketone is hexafluoroacetylacetone.

14. A computer-readable recording medium in which a computer program controlling a substrate processing apparatus is recorded,
wherein the computer program comprises:
controlling the substrate processing apparatus to supply a cleaning gas containing β-diketone and one of water and alcohol into a process chamber of the substrate processing apparatus having an insulative substance adhering to an inner part thereof, while the process chamber is set under a temperature that has been raised to not lower than 300° C. nor higher than 450° C., to cause a reaction of the insulative substance and the β-diketone contained in the cleaning gas, thereby forming a complex of a substance composing the insulative substance; and
controlling the substrate processing apparatus to discharge the complex out of the process chamber.

15. A computer-readable recording medium in which a computer program controlling a substrate processing apparatus is recorded,
wherein the computer program comprises:
controlling the substrate processing apparatus to supply a cleaning gas containing hexafluoroacetylacetone into a process chamber of the substrate processing apparatus having an insulative substance adhering to an inner part thereof, while the process chamber is set under a temperature that has been raised to not lower than 300° C. nor higher than 450° C. and the inner part of the process chamber is kept at a pressure of not lower than 1.33×10³ Pa nor higher than 1.33×10⁴ Pa, to cause a reaction of the insulative substance and the hexafluoroacetylacetone contained in the cleaning gas, thereby forming a complex of a substance composing the insulative substance; and
controlling the substrate processing apparatus to discharge the complex out of the process chamber.

16. A computer-readable recording medium in which a computer program controlling a substrate processing apparatus is recorded,
wherein the computer program comprises:
controlling the substrate processing apparatus to supply a cleaning gas containing β-diketone and oxygen into a process chamber of the substrate processing apparatus having an insulative substance adhering to an inner part thereof, to cause a reaction of the insulative substance and the β-diketone, thereby forming a complex of a substance composing the insulative substance; and
controlling the substrate processing apparatus to discharge the complex out of the process chamber.
